(19) United States
(12) Patent Application Publication
(10) Pub. No.: US 2014/0060305 A1
(43) Pub. Date: Mar. 6, 2014

(54) Armor with Tetrahedral Core

(71) Applicant: Howard A. Fromson, Stonington, CT (US)

(72) Inventor: Howard A. Fromson, Stonington, CT (US)

(21) Appl. No.: 13/716,753

(22) Filed: Dec. 17, 2012

Related U.S. Application Data
(60) Provisional application No. 61/630,817, filed on Dec. 19, 2011.

(51) Int. Cl. F41H 7/04; B23P 11/00

(52) U.S. Cl. CPC F41H 7/042; B23P 11/005
USPC 89/36.02; 29/505; 29/428

(57) ABSTRACT

An explosion resistant armor for use on a military vehicle and method of manufacture. The explosion resistant comprises a plurality of tubular core members rigidly secured together in adjacent rank formation. The rigidly secured core members are sandwiched between upper and lower plates, such that each core member is in the form of a chain of integrally interconnected hollow tetrahedrons.

### BACKGROUND

The present invention relates to armor, especially to explosion resistant armor plate or panels, and most especially to armor panels forming the belly of military vehicles for protection of personnel against mines and similar explosive devices.

Various methods of reinforcing the belly of military vehicles have been employed, particularly for vehicles that carry personnel into combat or into areas where improvised explosive devices may be detonated by contact or remotely. Nevertheless, although the reinforced or protected floors of the vehicles prevent penetration of shrapnel or the like into the vehicle cabin, the explosive shockwave accelerates the floor vertically to such an extent that the skeleton or musculature of personnel in the cabin is traumatized. It is known that such deleterious effects on the personnel can be ameliorated if the forces associated with the blast can be distributed or deflected to reduce the magnitude of the vertical component, but no satisfactory structural configuration has as yet been developed.

### SUMMARY

Briefly stated, a tetrahedral core such as the one described and claimed in U.S. Pat. No. 3,237,362, the disclosure of which is hereby incorporated by reference, provides a basis for improvements in the unrelated field of explosives armor.

By assembling a rigid array of tubular members, each in the form of a chain of integrally interconnected hollow tetrahedrons, a pair of parallel plates can be connected on opposite sides of the array and secured to the tubular members to form a panel structure. This panel can be incorporated as a horizontal floor or belly, or as an oblique component of an angled floor or belly.

The combination of tubular and triangular structure provides the dual advantages of absorbing high energy loads by collapsing at numerous buckling points, and in addition, distributing the energy forces in multiple planes. In this manner, a high fraction of the energy is distributed with a horizontal component, thus significantly reducing the vertical component which is the source of the trauma to personnel in a cabin.

In one general aspect, the invention is directed to explosion resistant armor, especially for or on a military vehicle, comprising a plurality of tubular core members rigidly secured together in adjacent rank formation and rigidly sandwiched between upper and lower plates, wherein each core member is in a form of a chain of integrally interconnected hollow tetrahedrons.

In another general aspect, the invention is directed to an explosion resistant armor panel, comprising a plurality of tubular core members rigidly secured together at adjacent rank formation and rigidly sandwiched between upper and lower plates. Each core member is constricted that linear sections transverse to the tubular member substantially closing the member at the sections and forming a chain of hollow tetrahedrons integrally connected at the constricted sections. The tubular members are folded about the constricted sections so that each pair of successive tetrahedrons have a pair of contiguous triangular faces respectively in face to face contact, and another pair of contiguous faces respectively extending in substantially coplanar relationship. In this matter, the tubular members are substantially in a form of a triangular prism. Means are provided for rigidly securing the tetrahedrons in face to face contact against relative movements.

Preferably, the core members are arranged with the tetrahedrons of each core member in registry, whereby confronting vertices are in conforming contacting alignment and are rigidly joined together along the contact, preferably by welding or the like along the full length for edge of each vertex as by welding. With the vertices or edges of the tetrahedrons rigidly secured together, the entire assembly or array of core members forms a monocoque. In this manner, the energy is not only distributed in multiple planes, the full three dimensional extent of the monocoque and thus minimizes and delocalizes deflection.

It can be appreciated that when a vehicle carrying personnel is subject to an explosion beneath the belly of the cabin, high energy pressure waves are distributed substantially vertically above the source of the explosion and angularly, and with both vertical and horizontal components at oblige angles to the horizontal, as result of the semi-isotropic nature of typical mines and IED's. An armor panel and especially an armor panel for the underbelly of a personnel carrier or the like is adapted to absorb the pressure pulses without the significant vertical displacement of the panel. Because the array of structural members between the plates originate as hollow tubes, they contribute far less weight to the overall armor panel than would be necessary for the same level of protection in other armor configurations.

Of course, this light weight construction and high energy dissipation efficiency is not intended for protection against high velocity projectiles or shaped charges in which substantially all of the kinetic energy of the projectile or charge would be extremely localized to the cross section of such projectile or shaped charge.

In accordance with the present invention, the tetrahedron is employed as the basic structural unit of the structural core. To that end, this core consists of a chain of integrally interconnected hollow tetrahedrons formed from a tubular blank of circular cross-section by transversely crimping or collapsing said blank at linear sections spaced therealong by the application of pinching pressures at these sections, successive sections being crimped by pressures acting in parallel planes transverse to the tubular blank but in different directions, and sections at equally spaced intervals greater than that between successive sections being crimped by pressures acting in parallel planes and in parallel directions. This crimping of the tubular blank in the manner described will constrict and substantially close the blank at these sections and will shape the blank into a succession or chain of hollow tetrahedrons integrally joined together along the edges of adjacent tetrahedrons at the crimped sections. Where the tubular blank is crimped in only two directions, the transverse outline of the resulting core as observed in end view will be generally rectangular, and in such cases, where the intervals between crimpings are equal, successive tetrahedrons will be mirror images of each other. Where these two directions are at right angles to each other, the transverse outline of the core as observed in end view will be generally square, and where these two directions are at an angle to each other, other than a right angle, the transverse outline of the core will be generally in the form of an oblong rectangle. This transverse rectangular configuration of the core whether square or oblong, permits a number of these cores to be arranged compactly side by side to form a unitary structure such as a flooring, platform or pontoon.

Where the tubular blank is crimped in more than two directions, the generally transverse outline of the resulting core as observed in end view will be generally in the form of a polygon having more than four sides, the number of sides being double the number of crimping directions employed.

The key to the strength of the structural core or web formed as described is the fact that a tetrahedron has the highest ratio of surface area per unit volume of any polyhedra and is therefore the most stable of all of the polyhedra. This comparatively high surface area imparts to a structure containing this core the highly desirable qualities of a stressed skin system.

A tetrahedron by definition is bounded by four planar triangular faces and has, therefore, six edges and four vertices. Each linear crimped section of the structural core constitutes the two merged edges of adjacent tetrahedrons and the ends of each of these sections define two apices of each of the tetrahedrons, each apex merging with the corresponding apex of the adjacent tetrahedron. With the linear crimped sections arranged as described, there are formed a plurality of parallel rows of apices extending along the core and arranged to encompass a geometric transverse area having four or more sides. With this geometric configuration and with the apices forming nodes in the structural core, it is possible to secure conveniently and stably to these apices along the core, ties in the form of rods, angle irons, strip sheets or panel sheets to produce a structure of generally transverse polygonal outline having four or more sides.

Where ties are arranged along the rows of apices of the core, these ties form chords between successive apices in each row and the resulting structure will be made up of a series of interconnected triangular truss units having the rigidity and stability incident to structural triangulation.

Although the tubular blank of circular cross-section has been collapsed at successive intervals by crimping to form a chain of tetrahedrons, this chain still has a tubular structure partaking of the characteristics of a structural skin system and retains thereby all of the high torsional or twist resistance of a tube. At the same time, it is isotropic in character in the nature of a space system. In such a system, owing to the interconnection of all the members, the applied external loads are distributed in all directions, thus reducing the high stresses in the directly loaded parts.

The tubular blank from which the core of the present invention is formed may have an imperforate wall or where extreme lightness is important, the tubular blank may have a series of perforations in the form of an expanded metal tube.

### BRIEF DESCRIPTION OF THE DRAWING

FIG. 1 is a perspective view of a tubular blank shown partly crimped in the process of converting it into a structural tetrahedral chain core of square transverse outline in accordance with one embodiment of the present invention;

FIG. 2 is a transverse section of the crimped tubular blank taken along the lines 2-2 of FIG. 1;

FIG. 3 is a transverse section of the crimped tubular blank taken along the lines 3-3 of FIG. 1;

FIG. 4 is a side elevation of a structure comprised of a tetrahedral chain core reinforced with tie rods along the rows of tetrahedral apices in accordance with optional feature;

FIG. 5 is a transverse section of the reinforced core taken along the lines 5-5 of FIG. 4;

FIG. 6 is a transverse section of a tetrahedral chain core reinforced with angle irons;

FIG. 7 is a perspective of a tetrahedral chain core reinforced by flat flanking sheets;

FIG. 8 is a transverse section of a tetrahedral chain core reinforced by a pair of angle irons conjointly enclosing the core;

FIG. 9 is a front elevation section of a composite structure comprising a series of tetrahedral chain cores side by side sandwiched between two rigid plates to form an armor panel;

FIG. 10 is a transverse section of the composite structure of FIG. 9 taken on lines 10-10 of FIG. 9;

FIG. 11 shows a side elevation of a tubular blank with indications of the crimping planes for forming a tetrahedral chain core;

FIG. 12 is a view partly in longitudinal section and partly in side elevation of a foldable tetrahedral chain core made by crimping the tubular blank of FIG. 11 in the planes indicated;

FIG. 13 is an end view of the core shown in FIG. 12;

FIG. 14 is a side elevation of a core unit made by collapsing the core of FIG. 12 in accordance with another embodiment of the present invention;

FIG. 15 is a top plane view of the core unit of FIG. 14;

FIG. 16 is a transverse section of the core unit of FIG. 14 taken on lines 16-16 of FIG. 14;

FIG. 17 is an underside perspective view of a representative military personnel carrier showing a panel in accordance with the present invention provided on a belly, immediately beneath the cabin; and

FIG. 18 is a schematic cross section of the armor panel of FIG. 16, showing an upper plate, lower plate, and a tetrahedral core sandwiched in between.

### DETAILED DESCRIPTION

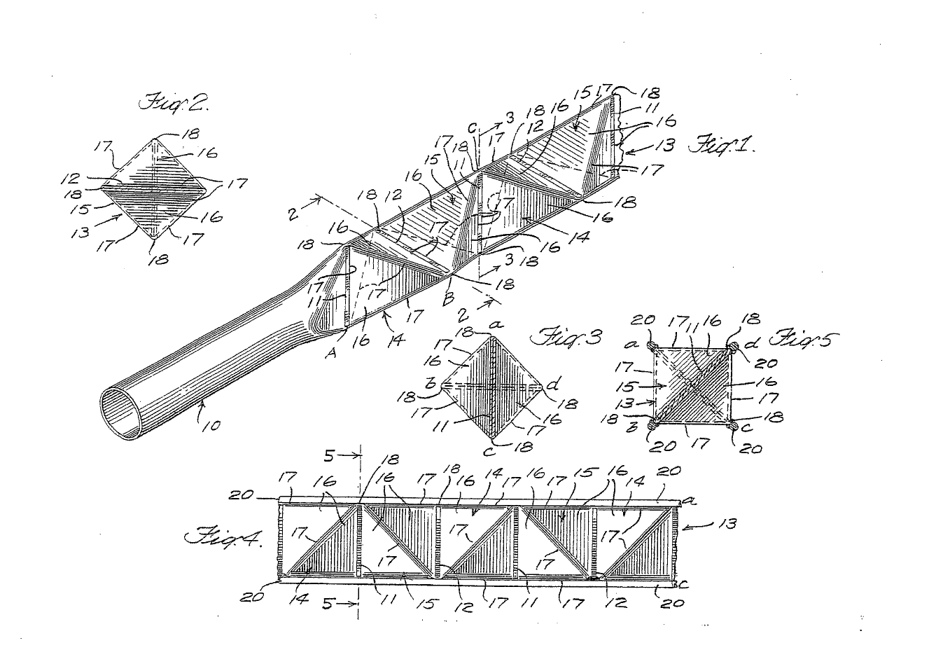

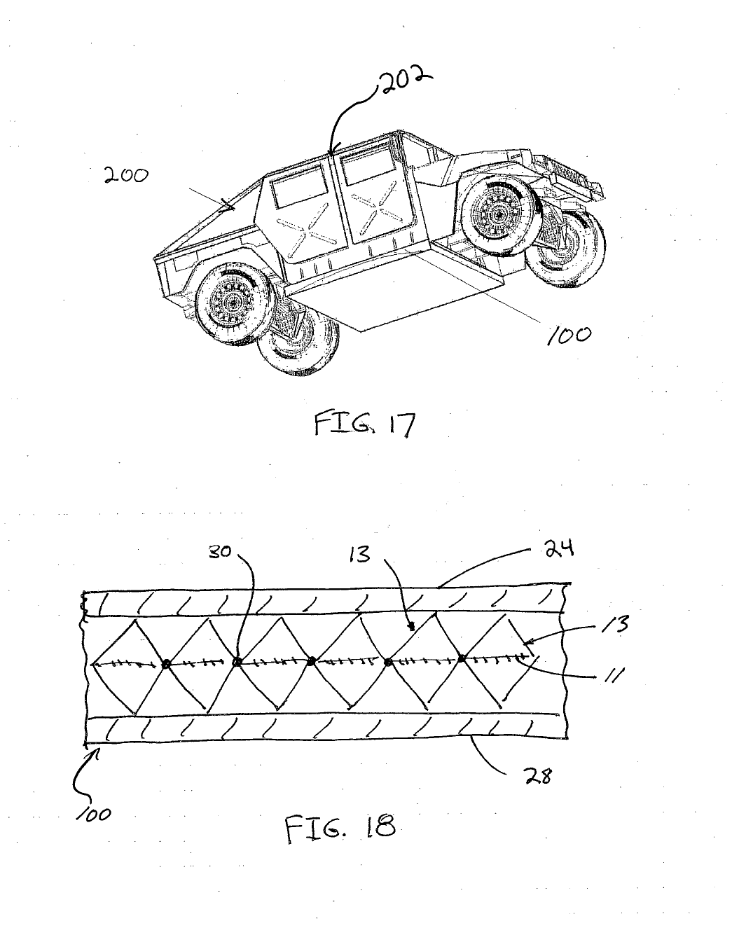

Referring to the drawings, wherein like numbers represent like parts throughout FIGS. 1-18, explosion resistant armor comprising a tetrahedral core is generally designated by the numeral 100.

FIG. 18, shows a representative military personnel carrier 200 carrying the explosion resistant armor 100, on or as the belly of the cabin 202. As shown in FIG. 18, the armor panel 100 has an upper plate 24, lower plate 28, and an array of tetrahedral core members 13 sandwiched in between. In the embodiment depicted in FIG. 18, the explosion resistant armor 100 is configured as an explosion resistant armor panel adapted for use on the belly of the personnel carrier 200. One of skill in the art will appreciate that the explosion resistant armor may be adapted for use in any number of vehicles or structures where explosion resistance is required.

The explosion resistant armor comprises a plurality of tubular core members 13 rigidly secured together as by welds 30 in adjacent rank formation and rigidly sandwiched between upper and lower plates 24 and 28, wherein each core member is in the form of a chain of integrally interconnected hollow tetrahedrons. The details of how such cores can be formed, arranged in an array, and connected together will be described below with reference to FIGS. 3-16.

FIGS. 1-3 show an imperforate tubular blank 10 of circular cross-section and specifically of cylindrical form made of bendable or deformable material such as metal, as for example, steel, copper and aluminum; the tubular blank can also be made of plastic material, and especially of thermoplastic material, so that it will be deformable upon heating. Other suitable materials may be paper and fibrous material embedded or bonded with plastic.

The tubular blank 10 may be welded, glued, seamless or lock-seamed and is crimped at spaced transverse linear sections 11 and 12 in planes at right angles to the axis of the tubular blank to collapse this blank along said sections and to form a structural core or web 13. This crimping operation may be performed while the tubular blank 10 is cold or hot according to the nature of the material from which said blank is formed and may be carried out in such a way that successive sections 11 and 12 are crimped in parallel planes but in different directions and alternate sections 11 or 12 are crimped in parallel planes and in parallel directions. Each of the crimped sections 11 and 12 is produced by collapsing the wall of the tubular blank 10 from diametrically opposite sides of the blank to an equal extent by a pinching action to form each crimped section substantially diametrically across the blank. In the specific form of the invention shown in FIGS. 1-3, the two sets of crimped sections 11 and 12 extend in planes at right angles to each other, so that the transverse general outline of the core is square, as shown in FIGS. 2 and 3. However, the two sets of crimped sections 11 and 12 may extend in planes at an angle other than 90° to each other to define a transverse core outline which is of rectangular oblong shape.

Also, in the construction of FIGS. 1-3, the crimped sections are equally spaced and the distances between these sections are such in relation to the diameter of the tubular blank as to form regular tetrahedrons, but as far as certain aspects of the invention are concerned, this is not necessary.

For producing the structural core or web 13, the tubular blank 10 is first crimped in a plane at right angles to the axis of the blank in diametrically opposed directions near one end of the blank to form a first crimped section 11 at the region A and to close the blank; the blank is then crimped at a linear interval from said first crimped section at right angles to the axis of the blank in diametrically opposed directions transverse to the first mentioned directions and more specifically at right angles to said first mentioned directions in accordance with the embodiments of FIGS. 1-3, to form a second crimped section 12 at the region B and to form thereby a hollow tetrahedron 14; and the blank is further crimped at the same linear interval at right angles to the axis of the blank in diametrically opposed directions parallel to the first mentioned directions to form a third crimped section 11 at the region C and thereby a second tetrahedron 15. This crimping action is continued for successive sections in alternate directions until the tubular blank 10 has been shaped into a structural core 13 having the desired configuration. This core 13 will consist of a chain of tetrahedrons 14 and 15 interconnected along the crimp sections 11 and 12 and arranged so that successive tetrahedrons are mirror images of each other in the form of optical antipodes.

Another alternative procedure for forming the tetrahedral chain core or web 13 is to crimp one end of the tubular blank 10 to close said blank. At a linear interval corresponding to two successive tetrahedrons, the blank is crimped in diametrically opposed directions parallel to the diametrically opposed first crimping directions to form a hollow pillow-shaped body between end crimp sections. A third crimp is then formed in the middle of the pillow-shaped body between these crimped sections but in diametrically opposed directions transverse to and specifically at right angles to the first crimping directions, in accordance with the embodiments of FIG. 3. This third crimp deforms the pillow-shaped body into two hollow tetrahedrons 14 and 15.

The tetrahedral chain structure 13 formed as described may be utilized effectively as a basic core or web element of explosion resistant armor 100. As shown, each of the tetrahedrons 14 and 15 is bounded by four substantially planar triangular faces 16 and will contain six edges 17, two of which are at opposite ends of the tetrahedron along successive crimped sections 11 and 12 and four vertices located at the ends of these crimp sections to define nodes or peaks 18. These structural nodes 18 are arranged in four parallel linear rows a, b, c and d extending along the core 13 and encompassing a rectangular area transverse to the core and more specifically a square area, as shown in FIGS. 2 and 3. Although not necessary, ties can be secured to these nodes 18 between adjacent tetrahedrons 14 and 15 to form in conjunction with successive triangular planar sections 16 of the tetrahedrons chains of interconnected triangular trusses. The ties and rigid lateral connections between adjacent cores 13 provide connective support to the tetrahedral chain structure 13, creating an armor panel as depicted in FIG. 18.

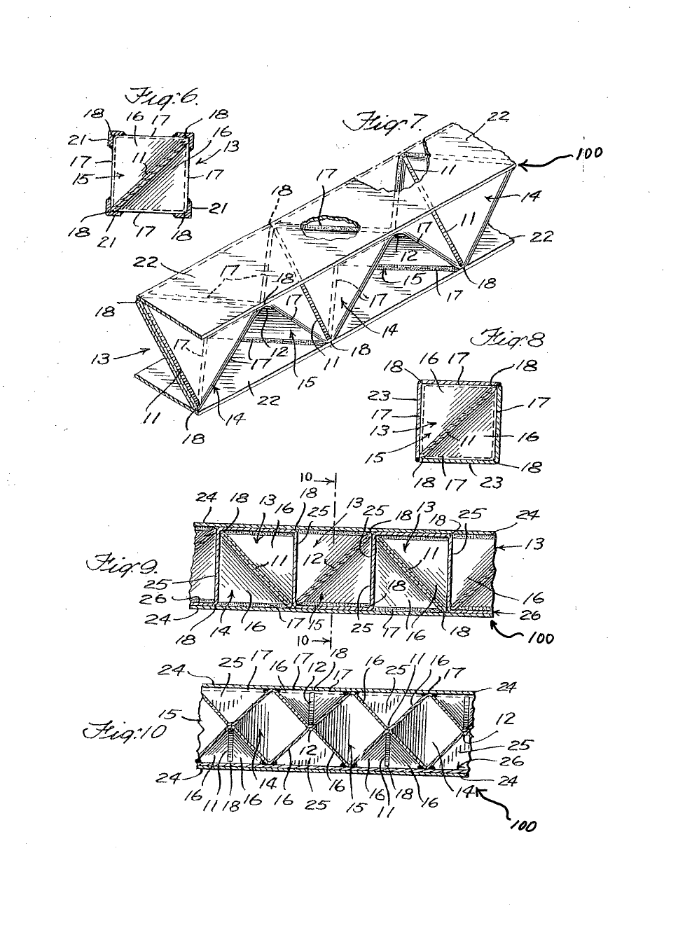

In FIGS. 4 and 5, the ties between the nodes of the core 13 are shown constituting steel rods or wires 20, brazed, welded or otherwise affixed to the core 13 at all nodes 18 in accordance with the nature of the core material, so that these rods or wires constitute parallel chords forming part of the structure unit. These chordal rods 20 serve to further rigidize the core 13 and to form a composite structure unit 13, 20.

Although the core of the composite structure unit 13, 20 has been deformed or prebuckled into a series of continuous tetrahedrons, it is still a tubular structure and still retains the high torsional or twist resistance of a tube. Moreover, the composite structure 13, 20 is isotropic in character. Its planar face sections 16 are equally strong and are oriented in different directions, so that the structure can stand stresses in all directions and will distribute stress applied in any region in all directions. The core structure 13 can be manufactured with ease from tubular stock of from ⅛″ diameter to as much as 6″ or more in diameter.

The composite unit 13, 20 has an unusually high strength to weight ratio because of the internally continuous braced skin structure and because of the fact that tetrahedrons have the highest ratio of surface area per unit volume of any regular polyhedrons, and consequently are the most stable of all polyhedrons. By combining this property of the tetrahedrons with the high twist resistance of the original tube, there has been created a very stable structure in which stresses are transmitted and resolved continuously in the web or core 13 and the chords 20 in which no points in the structure are usually stressed.

FIG. 6 shows a modification in which the round tie rods or wires 20 in the construction of FIGS. 4 and 5 are replaced by angle irons 21 serving as chordal ties between nodes 18. These angle irons 21 are snugly rested against the corners of the core 13 and in the case of a metal core may be brazed to the nodes 18 as shown. These angle irons 21 not only contact the core 13 at the nodes 18 but also contact part of the edges 17 of the tetrahedrons 14 and 15, so that stronger connections may be effected between these angle irons and the core by brazing or otherwise securing the angle irons to these contacting parts of the tetrahedral edges 17. Furthermore, these angle irons 21 can provide weld surfaces along substantially contacting edges 17 or nodes 18 when the cores 13 are aligned side by side with aligned edges 17.

The angle irons 21 may be welded, adhesively secured or otherwise affixed to the core 13 in accordance with the nature of the core material. For example, as another alternative, studs (not shown) may be affixed to the nodes 18 by welding or brazing, the angle irons 21 may have holes for impaling the angle irons 21 onto the studs, and nuts (not shown) may be screwed to the studs to retain the impaled angle irons in position.

FIG. 7 shows an alternative embodiment of the composite structure unit 13, 20 of FIGS. 4 and 5, in which the chordal ties between the nodes 18 are in the form of a pair of parallel strips of sheet material 22 extending along and affixed to the opposing sides of the tetrahedral chain core 13 in the regions where the core and the strips come into contact along the edges of the tetrahedrons 14 and 15, so that the resulting composite unit 13, 22 will assume the characteristics of an I-beam with the core 13 forming the web and the parallel strips of sheet material 22 forming the flanges.

The strips of sheet material 22 may be of steel where the tetrahedral chain core 13 is of steel or other metal, in which case the strips 22 may be brazed onto the core along the regions where the edges 17 of the tetrahedrons 14 and 15 contact said strips 22, or the strips 22 may be of any other material and may be secured to the core in any other suitable way according to the nature of the material from which the core is constructed.

FIG. 8 shows a construction in which the ties are in the form of continuous strips of sheet material extending along all sides of the tetrahedral chain core 13 to enclose entirely the core 13 on all sides and to form thereby a beam or column of rectangular outline. The strips may be in the form of two angles 23 nested against diagonally opposite corners of the core 13 and having their flanges wide enough to extend across the full widths of the core 13 respectively. These angles 23 are brazed, welded or otherwise affixed to the core along the edges of the tetrahedrons 14 and 15 contacting said angles, according to the material from which the core and angles are made.

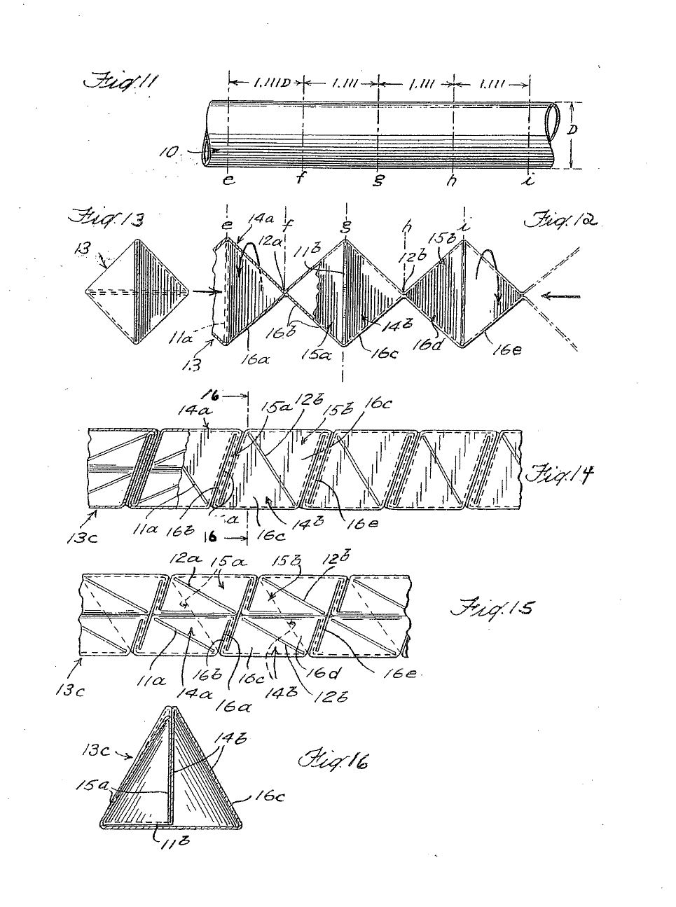

FIGS. 9 and 10 show a construction in which a plurality of structural cores 13 may be placed side by side in rank formation and rigidly secured together to form a flat armor panel structure 100. Upper and lower plates 24 and 28 of the array of structural cores 13, secured to these cores, serve not only as ties for the individual truss elements of the cores but as a means for securing the cores together and as a supporting platform. To provide a unitary structure in which stresses are more effectively transmitted from core to core, the cores 13 are secured together directly or indirectly. Preferably, the cores 13 are arranged with the tetrahedrons 14, 15 of each core in registry, whereby confronting vertices 17 are in conforming contacting alignment and rigidly joined together, as by welding, along substantially the entire the lines of contact.

If the cores 13 are not easily arranged in rank formation with the tetrahedrons of adjacent cores in transverse registry, the confronting edges of these tetrahedrons may not be directly in conforming contacting alignment. Such misaligned cores 13 will be in contact only over comparatively small areas and if such cores were directly connected together at these areas, the connections between the cores might not be too strong. To remedy this situation, intervening plates 25 can be provided between adjacent cores 13 and the cores directly connected to these plates 25 by welding or brazing in the case of metal or by any other means in the case of other materials. The cores 13 contact these intervening plates 25 along continuous zigzag lines constituting the interconnected edges 17 of the tetrahedrons 14 and 15 of these cores in the planes of the plates and are secured to these plates along these lines by welding, brazing or the like, even though adjacent cores may be out of transverse alignment. Firm interconnection of the cores 13 is thereby assured.

An even more rigid, stronger and more monolithic structural may be provided with a core retainer 26 of sheet material shaped into rectangular wave form to define a series of rectangular pockets in which the cores are respectively held, as shown in FIGS. 9 and 10. The intervening plates 25 may constitute the upright panel pieces of this retainer 26 and the cores may be connected by welding, brazing or otherwise to all of the panel pieces of this retainer including the upper and lower plates 24 and 28.

One advantage of the core structure so far described is that it can be collapsed, as for example, by rolling to reduce its dimensions to any size within a substantial range without unduly weakening the structure. For example, the structures of FIGS. 7 and 9 could be rolled to reduce the dimensions of the structure between the flanking sheets. The integrated isotropic nature of the core 13 causes the core under the compressive pressures described to collapse distributively over the entire core without local buckling and without failures incident to such localized buckling.

One of the features of the tetrahedral chain core of the present invention when said core has certain relative dimensions is that the core can be folded about its crimped sections 11 and 12 (FIGS. 2 and 3) by the application of combined compressive stress along the length of the core and torsional stress and can be collapsed, to bring the tetrahedrons 14 and 15 into face to face contact and to produce thereby a structural unit in the form of a triangular prism. For that purpose, the tetrahedral chain core must be made by crimping the tubular blank in a way that the length of tubular blank consumed per tetrahedron is about 1.1 and more specifically 1.111 times the diameter of the tube, as shown in FIG. 11, wherein the tubular blank 10 is shown with the crimping planes e, f, g, h . . . in the designated places along the tubular blank. The crimping of the tube in these planes e, f, g, h . . . in the directions described in connection with the construction of FIGS. 1-3, will produce the straight tetrahedronal chain core 13 shown in FIGS. 12 and 13 similar to that of FIGS. 2 and 3. By applying compressive pressure to the core 13 along its length, and at the same time twisting the ends of the core, as shown by the arrows in FIG. 12, the core will fold about the crimped sections 11 and 12 and collapse into compact cellular form, in which the tetrahedrons are brought together face to face to form a triangular prismatic structure unit 13c, as shown in FIGS. 14, 15 and 16. This collapsing operation may be carried out in successive segments along the core 13 until the entire core or the desired length thereof has been shaped as described.

In the core collapsing operation described, the two contiguous triangular faces of each pair of adjacent tetrahedrons 14 and 15 flanking each crimped section on one side of the section will come together in registering face to face contact, while the two contiguous triangular faces of said adjacent tetrahedrons on the opposite side of said crimped section will open up into coplanar relationship to define conjointly a rhombus constituting a part of the outside surface of the triangular prismatic structural unit produced.

To show more clearly how the tetrahedrons 14 and 15 are folded to produce the prismatic unit 13c of FIGS. 16, 17 and 18, adjacent tetrahedrons in the straight tetrahedral chain core are indicated as 14a, 15a, 14b and 15b, the crimped sections are indicated as 11a, 12a, 11b and 12b, and certain triangular faces of the tetrahedrons are marked 16a, 16b, 16c, 16d and 16e. FIGS. 16, 17 and 18 show the positions of these tetrahedrons, crimped sections and triangular faces, after the core of FIG. 14 has been folded as described.

The tetrahedrons 14 and 15 in the folded prismatic unit 13c can be brazed, soldered or adhesively secured together, as for example, by means of an epoxy resin, at the contacting faces of said tetrahedrons to form a cellular structural unit having unusual buckling resistance and strength characteristics. Where the unit 13c in use is subject to compressive stresses along its length, such connections between the tetrahedrons can be dispensed with. Also, instead of connecting the tetrahedrons at their faces, they may be connected together by longitudinal elements such as rods or angle irons secured by welding, soldering or brazing to the peaks of prism and extending along the prismatic unit.

The prismatic shape of the cellular structure 13c permits a number of these to be arranged compactly side by side, so that the structure is ideally suited to the fabrication of lightweight armor panels.

While the invention has been described with particular reference to specific embodiments, it is to be understood that it is not to be limited thereto but is to be construed broadly and restricted solely by the scope of the appended claims.

1. An explosion resistant armor for use on a military vehicle comprising a plurality of tubular core members rigidly secured together in adjacent rank formation and rigidly sandwiched between upper and lower plates, wherein each core member is in the form of a chain of integrally interconnected hollow tetrahedrons.

2. The armor of claim 1, wherein in said chain, the tetrahedrons are interconnected along crimp sections and arranged so that successive tetrahedrons are mirror images of each other in the form of optical antipodes.

3. The armor of claim 1, wherein
the tetrahedrons are interconnected along crimp sections;
each of the tetrahedrons is bounded by four substantially planar triangular faces and contains six edges, two of which are at opposite ends of the tetrahedron along successive crimped sections and four vertices located at the ends of these crimp sections to define nodes; and
the vertices of adjacent core members are rigidly secured together.

4. The armor of claim 1, wherein the core members are arranged with the tetrahedrons of each core member in registry, whereby confronting vertices are in conforming contacting alignment and rigidly joined together along the contact.

5. The armor of claim 3, wherein a connecting member is provided over at least a portion of each vertex and each connecting member rigidly connects a respective vertex to a vertex on an adjacent core.

6. The armor of claim 5, wherein each connecting member is a connecting plate extending between the upper and lower plates.

7. The armor of claim 1, wherein the armor forms an underbelly of a personnel cabin of a military vehicle.

8. An explosion resistant armor panel, comprising
a plurality of tubular core members rigidly secured together in adjacent rank formation and rigidly sandwiched between upper and lower plates;
each core member constricted at linear sections transverse to the tubular member substantially closing said member at said sections and forming a chain of hollow tetrahedrons integrally connected at said constricted sections, said tubular member being folded about said constricted sections so that each pair of successive tetrahedrons have a pair of contiguous triangular faces respectively in face to face contact, and another pair of contiguous faces respectively extending in substantially coplanar relationship, said tubular members being substantially in the form of a triangular prism; and
means for rigidly securing said tetrahedrons in face to face contact against relative movements.

9. The armor panel of claim 8, wherein
said tubular members if extended into straightened condition and transversely extended would be a cylindrical tube; and
the distance between the planes of constriction being equal to approximately 1.1 times the diameter of said tube.

10. The armor panel of claim 8 wherein adjacent core members are welded together.

11. The armor of claim 8, wherein the armor forms an underbelly of a personnel cabin of a military vehicle.

12. A method of forming explosion resistant armor comprising providing a chain of integrally interconnected hollow tetrahedrons by crimping a plurality of tubular core members at crimping angles perpendicular to a tubular core longitudinal axis at a plurality of crimp sections on each tubular core member;
rigidly securing each of said tubular core members in adjacent rank formation;
sandwiching said tubular core members between upper and lower plates.

13. The method of forming explosion resistant armor of claim 12, wherein crimping said plurality of tubular blanks comprises crimping successive sections at first and second crimping angles, said first crimping angle transverse to said second crimping angle.

14. The method of forming explosion resistant armor of claim 12, wherein providing a chain of integrally interconnected hollow tetrahedrons comprises crimping the tubular blanks such that successive tetrahedrons are mirror images of each other in the form of optical antipodes.

15. The method of forming explosion resistant armor of claim 12, wherein providing a chain of interconnected tetrahedrons comprises forming interconnected tetrahedrons along the crimp sections such that each tetrahedron is bounded by four substantially planar triangular faces and contains six edges, two of which are at opposite ends of the tetrahedron along successive crimped sections and defining nodes located at four vertices located at the ends of these crimp sections, and rigidly securing vertices of adjacent core members together.

16. The method of forming explosion resistant armor of claim 15, wherein rigidly securing vertices of adjacent core members together further comprises securing a connecting member over at least a portion of each vertex, and rigidly connecting a respective vertex to a vertex on an adjacent core member.

17. The method of forming explosion resistant armor of claim 16, wherein securing a connecting member over at least a portion of each vertex comprises shaping sheet material into a core retainer having a rectangular wave form defining a series of rectangular pockets, inserting each of the core members into one of the rectangular pockets, securing each of the core members within the core retainer, and connecting the upper and lower plates to the core retainer and core members.

18. The method of forming explosion resistant armor of claim 12, wherein the crimping angles of successive sections are perpendicular to one another, the crimping angles of alternating sections are parallel to one another, and the distance between successive.

19. The method of forming explosion resistant armor of claim 12, further comprising the step of attaching the explosion resistant armor to the underbelly of a personnel cabin of a military vehicle.

20. A method of forming explosion resistant armor comprising constricting a plurality of tubular core members at linear sections transverse to a longitudinal axis of the tubular member substantially closing said member at said sections and forming a chain of hollow tetrahedrons integrally connected at said constricted sections, folding said tubular member about said constricted sections so that each pair of successive tetrahedrons have a pair of contiguous triangular faces respectively in face to face contact, and another pair of contiguous faces respectively extending in substantially coplanar relationship, said tubular members being substantially in the form of a triangular prism; and
rigidly securing said tetrahedrons in face to face contact against relative movements; and
rigidly securing the tubular core members together in adjacent rank formation and rigidly sandwiching said core members between upper and lower plates.
